(19) United States
(12) Patent Application Publication
(10) Pub. No.: US 2024/0322749 A1
(43) Pub. Date: Sep. 26, 2024

(54) RAIL FIXING ASSEMBLY

(71) Applicant: GREENEC CORP., Aurora, IL (US)

(72) Inventors: Fugen LI, Xiamen (CN); Binglong ZENG, Xiamen (CN); Zhiwei SHI, Xiamen (CN)

(73) Assignee: GREENEC CORP., Aurora, IL (US)

(21) Appl. No.: 18/396,051

(22) Filed: Dec. 26, 2023

(30) Foreign Application Priority Data
Mar. 20, 2023 (CN) 202320548345.5
Oct. 18, 2023 (CN) 202322799517.9

(51) Int. Cl. H02S 30/10; F16B 7/04; H02S 20/23

(52) U.S. Cl. CPC H02S 30/10; F16B 7/044; H02S 20/23

(57) ABSTRACT

Disclosed is a rail fixing assembly, configured to fix a rail formed by connecting rail blocks, and including a base, pressing blocks, a movable clamping block and a fixing part; an installation groove is formed in the base, the pressing block is disposed above the base, an installation hole is formed in the pressing block, the lower end of the movable clamping block is inserted into the installation groove after passing through the installation hole and may move or rotate in the installation groove; the rail block is installed at the upper end of the movable clamping block, the movable clamping block moves or rotates in the installation groove to realize displacement or angle adjustment, the side wall of the rail block abuts against the pressing block. The application is convenient for fine adjustment during rail installation, so as to enable the installation more convenient and improve the installation efficiency.

### CROSS-REFERENCE TO RELATED APPLICATIONS

This application claims priority to Chinese Patent Application No. 202320548345.5, filed on Mar. 20, 2023 and Chinese Patent Application No. 202322799517.9, filed on Oct. 18, 2023. All of the aforementioned applications are incorporated herein by reference in their entireties.

### TECHNICAL FIELD

The application relates to the technical field of building installation, in particular to a rail fixing assembly.

### BACKGROUND

An existing solar photovoltaic module is generally supported on the roof through a lower rail during installation, and to meet the requirement of project site, the rail needs to be spliced on site during rail laying.

A rail connecting structure for fixing a photovoltaic module, which is similar to that described in Chinese patent No. CN217824858U in the relevant art, belongs to the technical field of photovoltaic module installation, and includes a first connecting rail and a second connecting rail, a groove is formed in one side of the first connecting rail, a fixing tube is slidably connected to an inner cavity of the second connecting rail, and one end of the fixing tube sequentially penetrates through the second connecting rail and the groove and extends into an inner cavity of the groove to be provided with a fixing box; through the arrangement of the first connecting rail, the second connecting rail, the fixing tube, the fixing box, a fixing mechanism and a moving mechanism, the moving mechanism may drive the fixing tube to move, and the fixing tube drives the fixing box to move.

For the rail connecting structure in the above-mentioned application, an angle or height cannot be adjusted, if bases are not adjusted to be on one straight line or the heights of the bases are not uniform, the bases need to be re-fixed, resulting in high construction cost, meanwhile, the structure is complicated, the construction speed is low, so that the construction period of a photovoltaic project is prolonged, and the installation efficiency of the photovoltaic module is lowered.

### SUMMARY

An objective of the application is to provide a rail fixing assembly, which is convenient for fine adjustment during rail assembly installation, so as to enable the installation more convenient and improve the installation efficiency.

In order to realize the purpose, the technical solution adopted by the application is as follows.

A rail fixing assembly is configured to fix a rail formed by connecting rail blocks and includes a base, pressing blocks, a movable clamping block and a fixing part. An installation groove is formed in the base, the pressing block is installed above the base, an installation hole is formed in the pressing block, and the lower end of the movable clamping block is inserted into the installation groove after passing through the installation hole and may move or rotate in the installation groove. The rail block is installed at the upper end of the movable clamping block, the movable clamping block moves or rotates in the installation groove to realize-displacement or angle adjustment, the side wall of the rail block abuts against the pressing block, and the pressing block is fixed on the base through the fixing part.

The application has the following beneficial effects.

Firstly, the movable clamping block moves or rotates in the installation groove of the base, so that the position and angle of the pressing block in the base change, then the angle of the rail block is adjusted within a certain angle range (preferably, the range of 10°), the pressing block may be adjusted within a certain displacement range (for example, the range of 45 mm) in the installation groove of the base, and the convenience of construction is improved.

Secondly, the rail block is abutted through corrugations on two sides of the first pressing block and the fifth pressing block and may be adjusted in the vertical direction during installation, thus adjustment of the rail in the height direction is realized, the convenience of construction is improved, meanwhile, due to the arrangement of the corrugations on two sides, the friction force is improved, and the engagement is more stable.

Thirdly, the rail block is installed through the second pressing block, the third pressing block and the fourth pressing block, the second pressing block and the third pressing block are pre-assembled through a second clamping part and a third clamping part, so that the fixing assembly may be assembled in advance before shipment, and the rail blocks may be rapidly installed on a construction site.

Lastly, metal elastic sheets are equipped, so that certain conductivity and friction force are increased, and relative sliding of the rail block and a connecting strip is prevented.

### BRIEF DESCRIPTION OF THE DRAWINGS

FIG. 1 is a schematic diagram of an overall structure of Embodiment 1 of the application.

FIG. 2 is a schematic diagram of a front view of FIG. 1.

FIG. 3 is a schematic diagram of a section view A-A of FIG. 2.

FIG. 4 is a state schematic diagram after installation of a rail block of Embodiment 1.

FIG. 5 is a schematic diagram of a perspective view from another angle of FIG. 4.

FIG. 6 is a schematic diagram of an exploded view of a connecting strip and a metal elastic sheet.

FIG. 7 is a schematic diagram of a detail view of A in FIG. 6.

FIG. 8 is a schematic structure diagram of a rail block.

FIG. 9 is a schematic structure diagram of a base.

FIG. 10 is a schematic structure diagram of a fifth pressing block.

FIG. 11 is a schematic structure diagram of a first pressing block.

FIG. 12 is a state schematic diagram when a rail block is installed at a higher position of Embodiment 1.

FIG. 13 is a state schematic diagram when the rail block in FIG. 12 is moved downwards to be adjusted to a lower position.

FIG. 14 is a state schematic diagram that a plurality of rail blocks are installed to form a rail in Embodiment 1.

FIG. 15 is a state schematic diagram of a top view of FIG. 12.

FIG. 16 is an installation schematic diagram after angle ß is adjusted when a rail block is installed in FIG. 15.

FIG. 17 is a schematic diagram of a front view of Embodiment 2 of the application.

FIG. 18 is a schematic structure diagram of a second pressing block.

FIG. 19 is a schematic structure diagram of a third pressing block.

FIG. 20 is a schematic structure diagram from another perspective of FIG. 19.

FIG. 21 is a schematic structure diagram of a fourth pressing block.

FIG. 22 is a schematic diagram of an exploded view of Embodiment 2 of the application.

FIG. 23 is a state schematic diagram when a rail block is installed on a construction site after a second pressing block, a third pressing blocking and a fourth pressing block are pre-assembled.

FIG. 24 is a state schematic diagram when a second pressing block is separated from a third pressing block.

FIG. 25 is a state schematic diagram when a second pressing block downwards presses a third pressing block.

FIG. 26 is a state schematic diagram when a second elastic piece is compressed to downwards lock a nut.

FIG. 27 is a schematic diagram of a perspective view of FIG. 26.

FIG. 28 is a state schematic diagram that a plurality of rail blocks are installed to form a rail in Embodiment 2, and an installation angle of a rail block is adjusted in the figure.

FIG. 29 is a state schematic diagram that a plurality of rail blocks are installed to form a rail in Embodiment 2, and the vertical position of a rail block is adjusted in the figure.

### DETAILED DESCRIPTION OF THE EMBODIMENTS

The technical solutions of the application will be further described below with reference to drawings and through specific implementation modes.

### Embodiment 1

The application provides a rail fixing assembly, which is configured to fix a rail formed by splicing rail blocks 1.

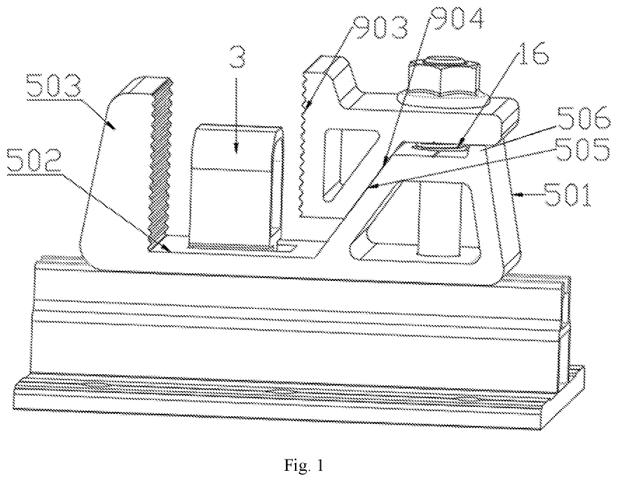

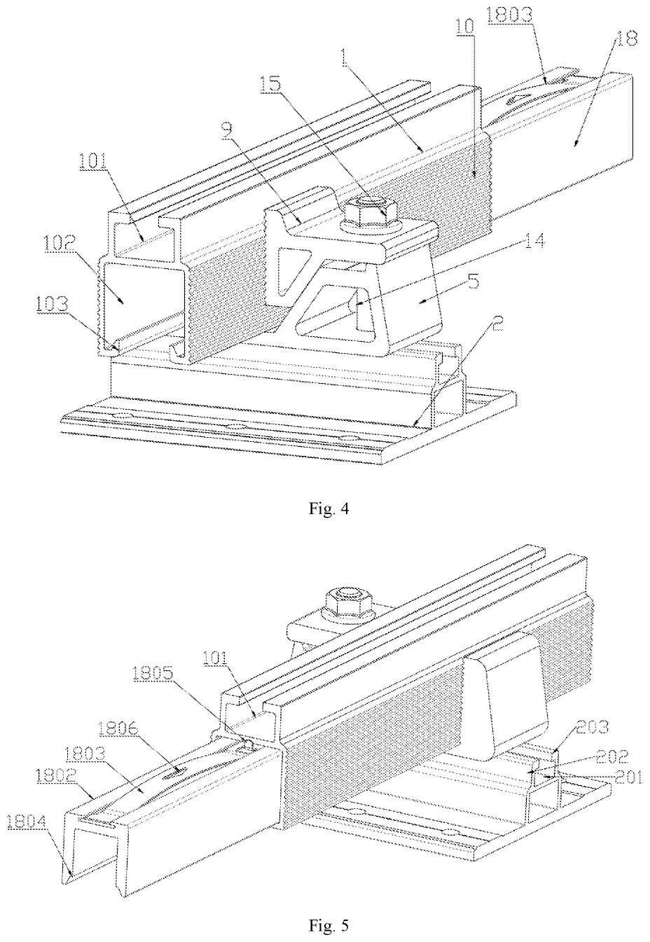

As shown in FIGS. 1-16, the rail fixing assembly includes a base 2, pressing blocks, a movable clamping block 3 and a fixing part.

As shown in FIG. 9, a fixed seat 202 is installed on the base 2, an installation groove 201 is formed in the fixed seat 202, and clamping steps 203 are disposed on two sides, at an opening, of the installation groove 201.

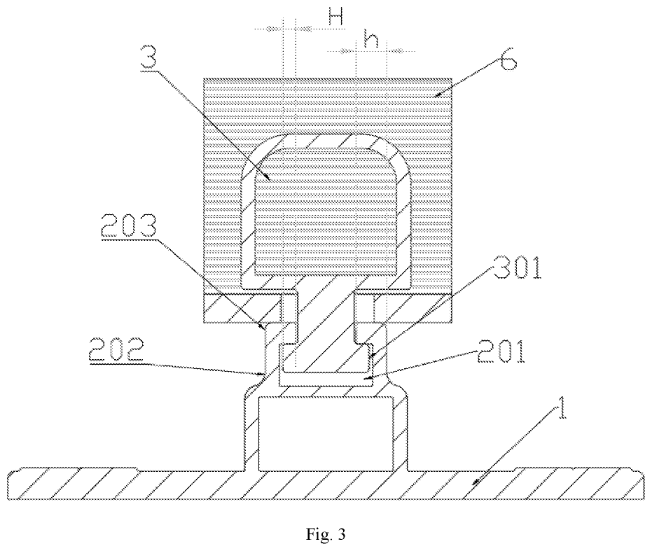

The pressing blocks are installed above the base 2, in the embodiment, the pressing blocks include a first pressing block 5 and a fifth pressing block 9. As shown in FIG. 11, the first pressing block 5 includes a fixing part 501, an adjusting part 502 and a first clamping part 503, the height of the adjusting part 502 is smaller than those of the fixing part 501 and the first clamping part 503, which is equivalent that the adjusting part 502 sinks into the first pressing block 5, so that the rail blocks 1 may be installed in the adjusting part 502. A bulge 506 is configured above one side of the fixing part 501, and a slope 505 is disposed on the other side. An installation hole 4 is formed at the bottom of the adjusting part 502, and the movable clamping block 3 is installed in the installation hole 4. As shown in FIG. 3, a clamping table 301 is disposed at the bottom of the movable clamping block 3, the clamping table 301 passes through the installation hole 4 to be clamped on the clamping steps 203 of the installation groove 201 of the fixed seat 202 of the base 2, since the width of the installation hole 4 is greater than the maximal width of the movable clamping block 3 and the width of the clamping step 203 is greater than that of the clamping table 301, the movable clamping block 3 may rotate within a certain range of the installation hole 4 and the installation groove 201, and therefore, the installation angle of the rail block 1 may be adjusted.

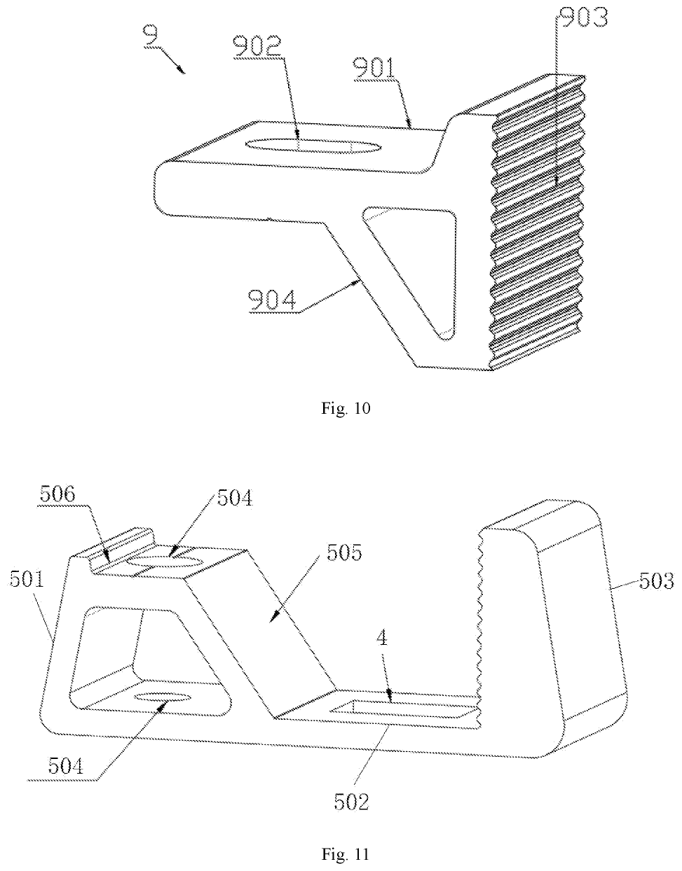

As shown in FIG. 10, a fifth pressing block 9 is fixed on the first pressing block 5, a horizontal pressing block plane 901 is configured on one side of the fifth pressing block 9, the pressing block plane 901 is installed on the fixing part 501, a pressing block hole 902 is formed in the pressing block plane 901, a vertical fixed plane 903 is disposed on the other side of the fifth pressing block 9, and an accommodating space configured for installing the rail blocks 1 is formed between the fixed plane 903 and the first clamping part 503. In order to facilitate installation of the rail block 1, one side of the first clamping part 503, contacting the rail block 1, of the first pressing block 5 is also configured to be a vertical fixed face, corrugations 10 are disposed on both the fixed plane 903 and the first clamping part 503, corrugations are further disposed on two sides of the rail block 1, so that two sides of the rail block 1 are tightly clamped with the fixed plane 903 and the first clamping part 503, and the installation is more stable. A fourth bevel 904 is configured on the side, contacting the first pressing block, of the fifth pressing block 9, the fourth bevel 904 is located below the pressing block plane 901, during installation, the fourth bevel 904 attaches to the slope 505, through attaching of the fourth bevel 904 with the slope 505, when the fixing part is downwards locked, under the action of the slope, the fifth pressing block enables the fixed plane 903 to move towards one side of rail block 1, thereby pressing the rail block 1.

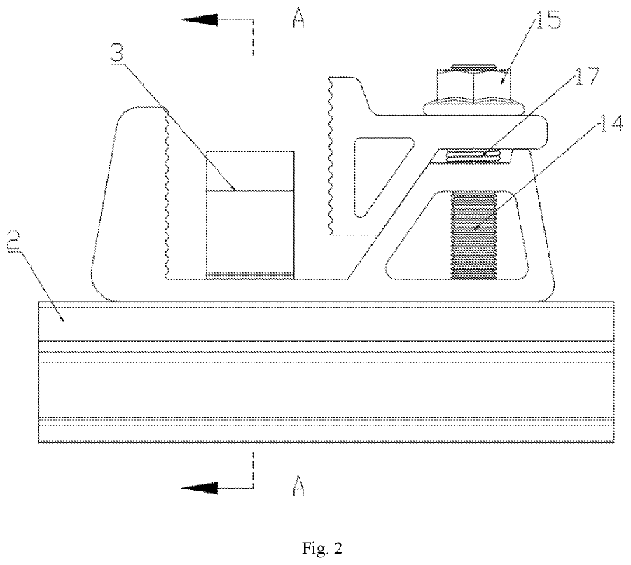

As shown in FIGS. 1 and 2, the fixing part includes a second bolt 14 and a second nut 15, the head of the second bolt 14 is disposed in the installation groove 201 and limited on the clamping step 203, and the tail of the second bolt 14 passes through the fixing hole 504 and the pressing block hole 902 and is locked by the second nut 15. When the fifth pressing block 9 is installed on the first pressing block 5, due to the configuration of the bulge 506, a gap 16 exists between the first pressing block 5 and the fifth pressing block 9, a second elastic part 17 is installed in the gap 16, the second elastic part 17 may be a spring, the spring is threaded in the second bolt 14, and the second bolt 14 is threaded on the spring after passing through the fixing hole 504 from the base 2, and then is threaded above the pressing block hole 902 and locks the second nut 15. The spring is installed in the gap 16, so that a certain elastic force is available when the first pressing block 5 and the fifth pressing block 9 are locked, and the fixation is tighter.

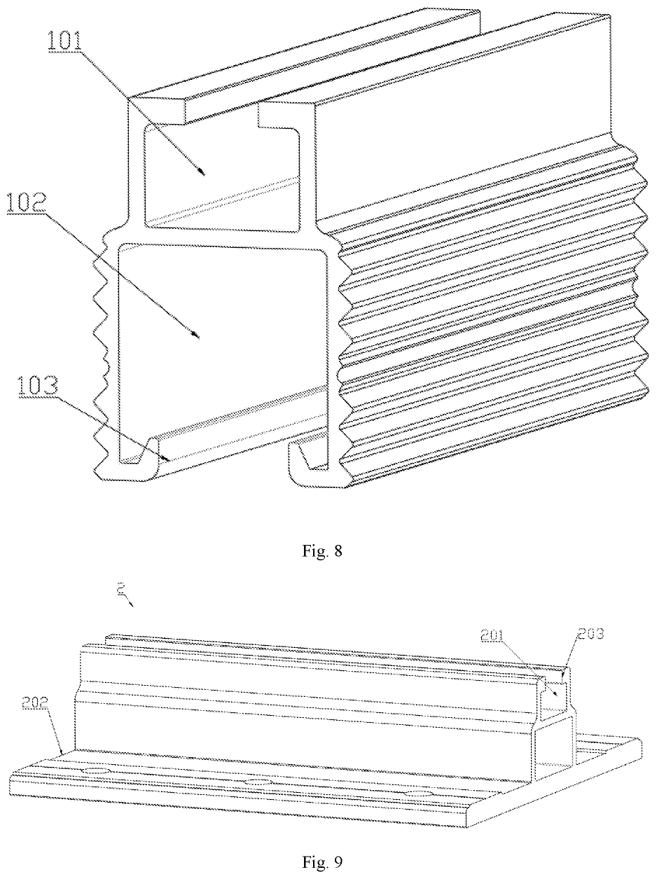

As shown in FIG. 8, a base groove 101 and a channel 102 configured for installing a photovoltaic module are disposed on the rail block 1, and a clamping hook 103 is disposed at the bottom of the channel 102. In order to realize splicing of the rail blocks, a connecting structure is utilized, and the connecting structure is installed in the channel 102 of the rail block 1.

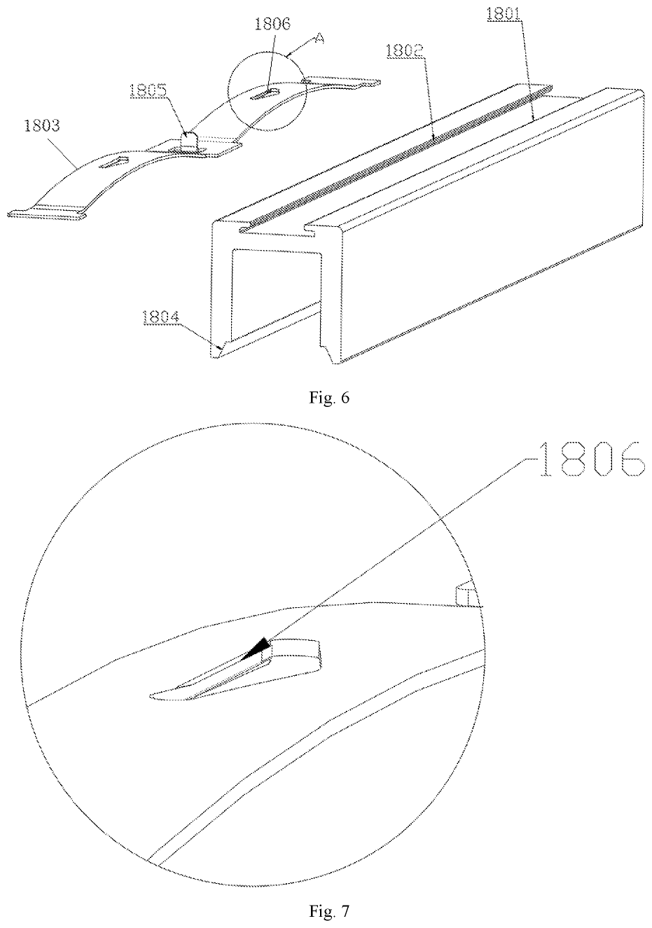

As shown in FIG. 6, the connecting structure includes a connecting strip 18, an installation notch 1801 is formed in the connecting strip 18, guide lugs 1802 are configured on two sides of the installation notch 1801, a metal elastic sheet 1803 is disposed in the installation notch 1801, and an installation ramp 1804 is disposed at the bottom of the connecting strip 18. The installation ramp 1804 is adaptive to the clamping hook 103. Two sides of the metal elastic sheet 1803 are limited by the guide lugs 1802. A convex block 1805 is disposed in the middle of the metal elastic sheet 1803. As shown in FIG. 5, during installation, part of the connecting strip 18 extends into the channel 102 of one rail block 1, and the other part extends into the channel 102 of the adjacent rail block 1, so that the installation ramp 1804 below is located on the clamping hook 103, and the convex block 1805 above is located on the outer side wall between the two rail blocks 1 and attaches to the outer side wall, thereby preventing the relative sliding between the rail blocks 1 and the connecting strip 18. As shown in FIG. 7, after the connecting strip 18 is installed between the two rail blocks 1, a scraper 1806 on the metal elastic sheet 1803 attaches to the bottom of the channel 102 of the rail block 1, the rail block 1 is covered with an oxide layer, and the scraper 1806 may scratch the oxide layer to increase certain conductivity and friction.

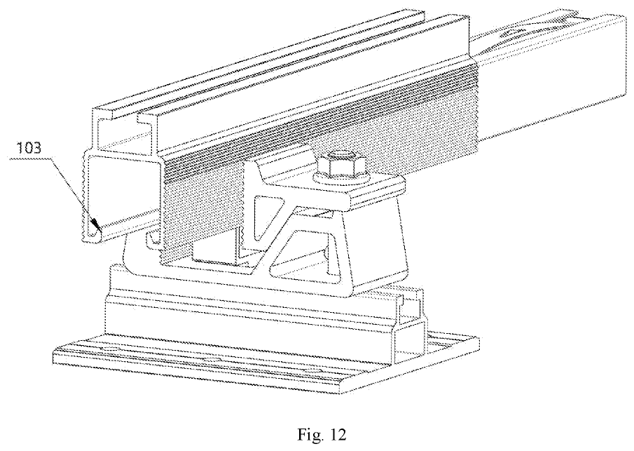

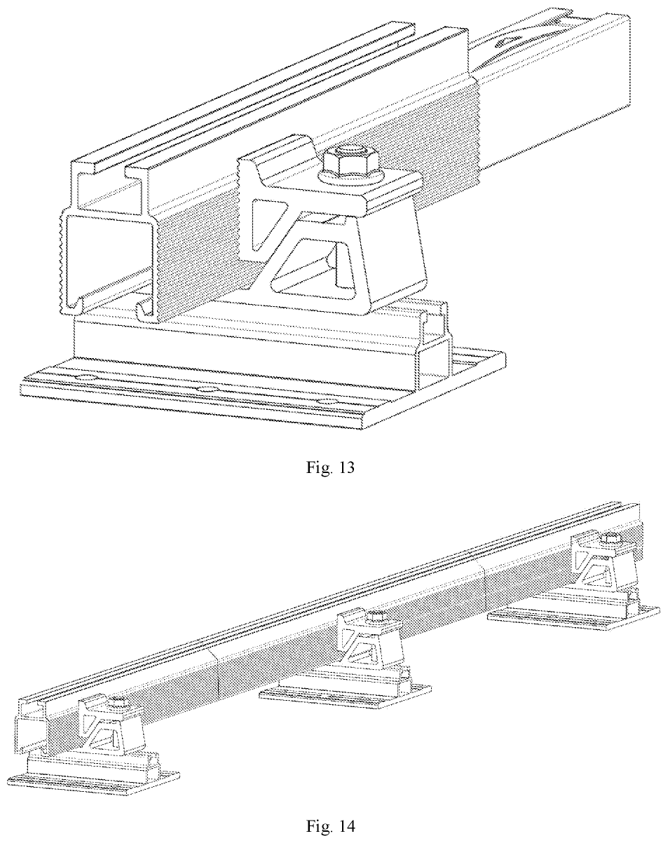

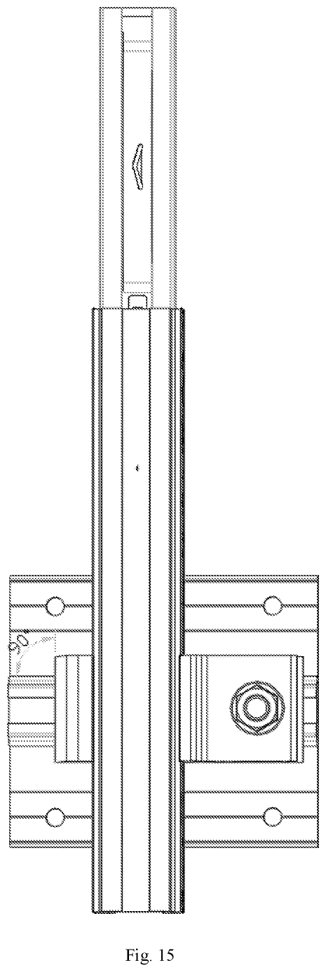

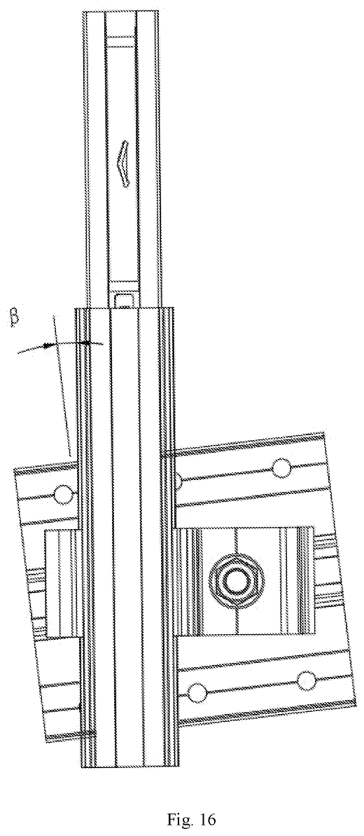

As shown in FIG. 14, the rail blocks are installed and supported by the rail fixing assembly, and several rail blocks are connected through the connecting structure. During installation, due to unevenness of the installation conditions, the adjustment of height position and angle is required. As shown in FIGS. 12-13, the fixing part may be locked after the height of the rail block is adjusted. As shown in FIGS. 15-16, since both the movable clamping block 3 and the pressing block may rotate by a certain angle (the adjustment range is within 10°) on the base 2, and due to synchronous adjustment of the pressing block within the adjustment range of 45 mm in the installation groove 12 of the base 2, the angle adjustment of the rail block 1 may be realized. Through adjustment of height and angle, construction is more convenient.

During installation, first, the clamping table 301 of the movable clamping block 3 passes through the installation hole 4, then the first pressing block 5 and the movable clamping block 3 are installed on the base 2 together, the angles of the first pressing block 5 and the movable clamping block 3 with the base 2 are adjusted, then the rail blocks 1 are installed on the movable clamping block 3, finally, the fifth pressing block 9 is placed on the first pressing block 5, and the second nut 15 is downwards locked, so that the fifth pressing block 9 moves towards one side of the rail block 1 till attaching to and locking with the side end of the rail block 1.

### Embodiment 2

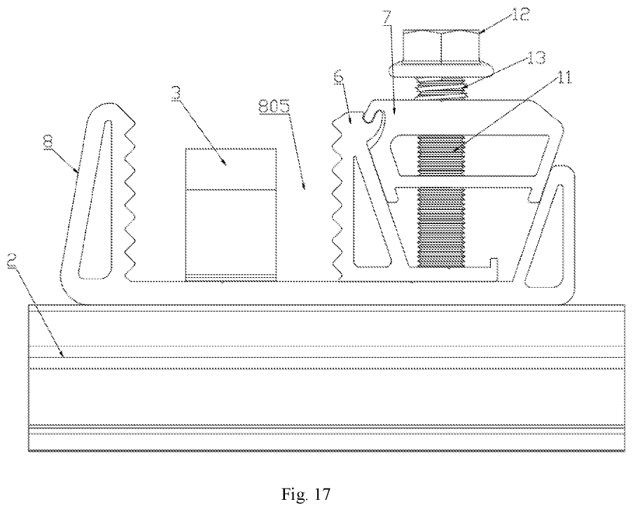

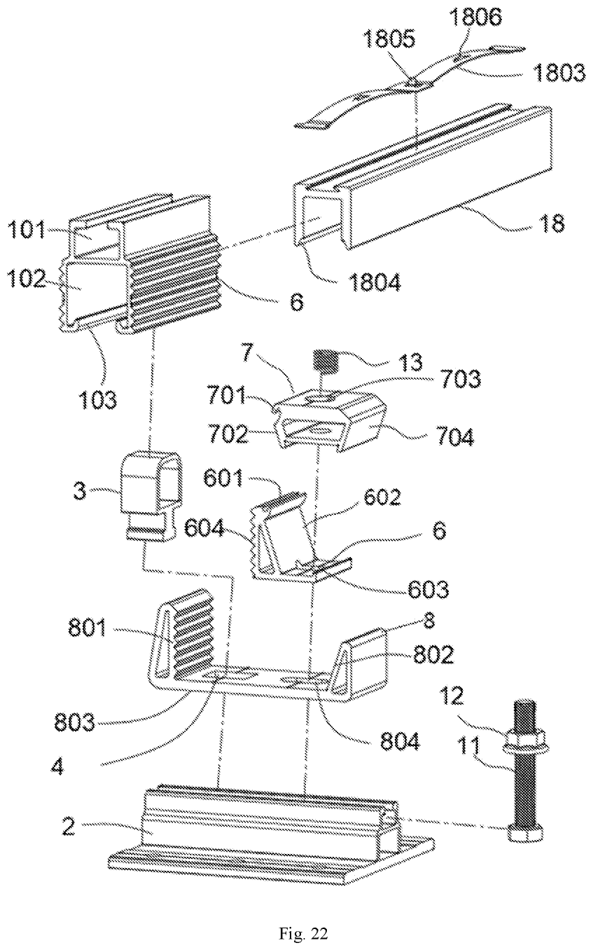

As shown in FIGS. 17-29, the embodiment differs from Embodiment 1 in that the structure of the pressing block in the embodiment is different from that in Embodiment 1. As shown in FIG. 17, the pressing block in the embodiment includes a second pressing block 6, a third pressing block 7 and a fourth pressing block 8. The fixing assembly of the embodiment may be pre-assembled in advance before shipment, so that site construction time may be reduced, assembly may be carried out rapidly when a rail is installed on side, and installation steps are reduced.

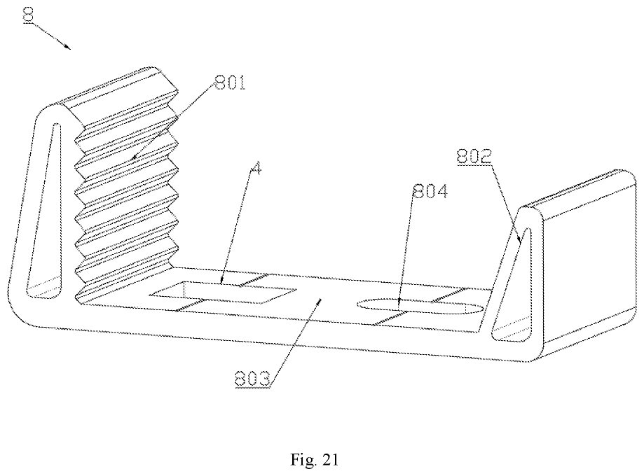

As shown in FIG. 21, a first clamping face 801 and a second clamping face 802 are configured on two sides of the fourth pressing block 8, and a bottom face 803 is connected between the first clamping face 801 and the second clamping face 802. A locating hole 804 is formed in the bottom face 803. The second pressing block 6 is installed in the middle of the bottom face 803.

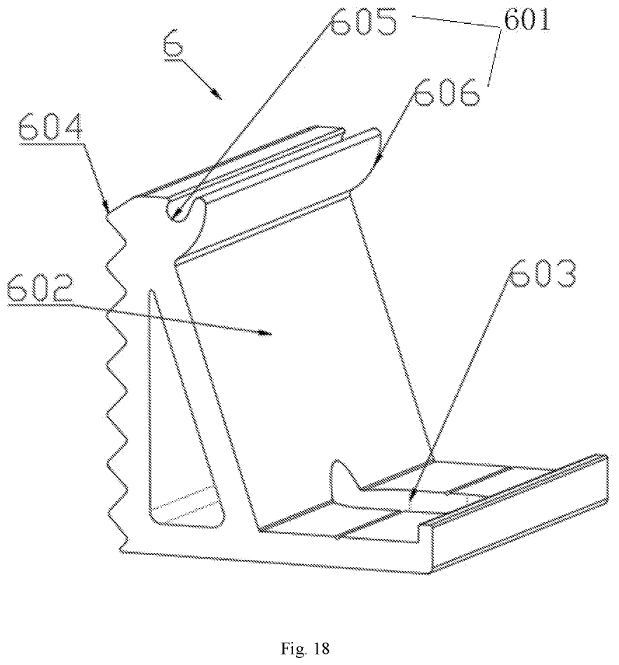

As shown in FIG. 18, a second clamping part 601, a first bevel 602 and a slot hole 603 are configured on the second pressing block 6. The first bevel 602 is configured at the position, contacting the third pressing block 7, of the second pressing block 6. A first groove 605 and a first lug 606 are configured on the second clamping part 601. The side, close to the first clamping face 801, of the second pressing block 6 is configured to be a third clamping face 604. An accommodating space 805 configured for installing rail blocks 1 is formed between the third clamping face 604 and the first clamping face 801, as shown in FIG. 17. Corrugations are configured on both the first clamping face 801 and the third clamping face 604, for realizing close connection with corrugations on two sides of the rail block 1.

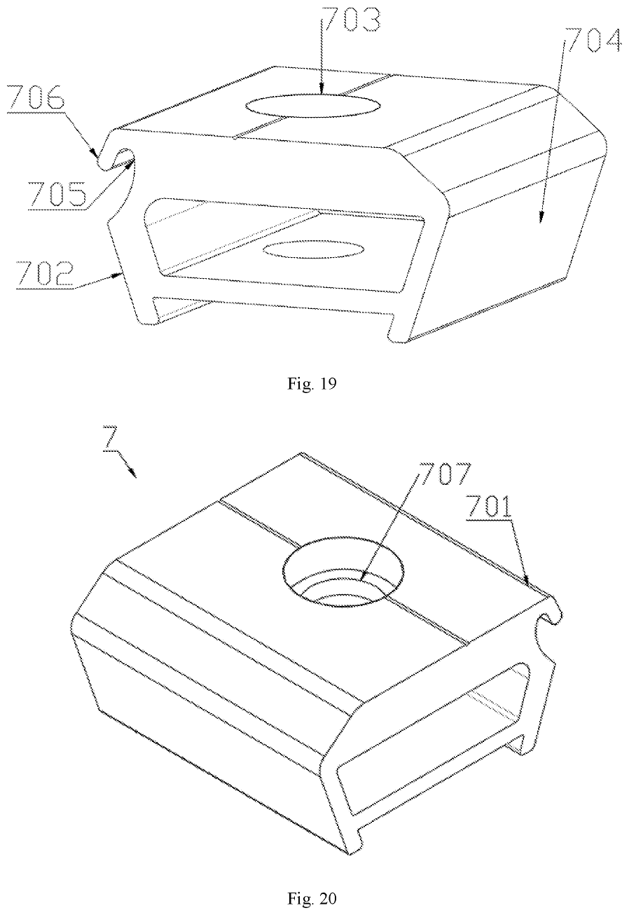

As shown in FIGS. 19 and 20, the third pressing block 7 is installed between the first bevel 602 and the second clamping face 802. A third clamping part 701, a second bevel 702 and a through hole 703 are disposed on the third pressing block 7. A second-groove 705 and a second lug 706 are disposed on the third clamping part 701. The first raised part 606 is clamped in the second groove 705, the second lug 706 is clamped in the first groove 605, the depth of the first groove 605 is smaller than that of the second groove 705, and the convex length of the first lug 606 is greater than that of the second lug 706, so that the clamping of the second pressing block 6 and the third pressing block 7 is not prone to disengagement.

In order to enable the mutual extrusion between the third pressing block 7 and the second pressing block 6 to be more labor-saving and smooth, the second bevel 702 of the third pressing block 7 and the third bevel 704 are configured to be tilted inward from top to bottom, forming an inverted splay shape, the included angle between the first bevel 602 and the third clamping face 604 of the second pressing block 6 is designed to be 15°-45° (preferably 19°), meanwhile, on the other side of the third pressing block 7, the included angle between the second clamping face 802 and a vertical plane is also designed to be 15°-45° (preferably 19°). The third bevel 704 attaches to the second clamping face 802, which facilitates the third pressing block 7 to act on the second pressing block 6 in the extrusion process and the second pressing block 6 to move in a direction away from the third pressing block 7 under the dual action of gravity and the fixing part.

The fixing part includes a first bolt 11, a first nut 12, and a first elastic part 13, and the first bolt 11 is inserted from an installation groove 701 of a base 2, and is fixed through the first nut 12 after sequentially passing through the locating hole 804, the slot hole slot hole 603, the through hole 703, and the first elastic part 13. As shown in FIG. 20, the first elastic part 13 is disposed as a spring, and in order to facilitate the installation of the spring, a stepped groove 707 for accommodating the spring is disposed on the through hole 703 of the third pressing block 7.

The fixing part is inserted into the slot hole slot hole 603 of the second pressing block 6 and through hole 703 of the third pressing block 7. During pre-assembly, the second pressing block 6 is clamped with the second clamping part 601 and the third clamping part 701 of the third pressing block 7, the bottom and the second bevel 702 attaches to the first bevel 602, and meanwhile, the fixing part is located on one side of the slot hole slot hole 603. In such a case, since the second clamping part 601 is clamped with the third clamping part 701, enough accommodating space may be reserved for installing the rail block 1 on site.

The specific steps for installing the rail blocks on site are detailed below.

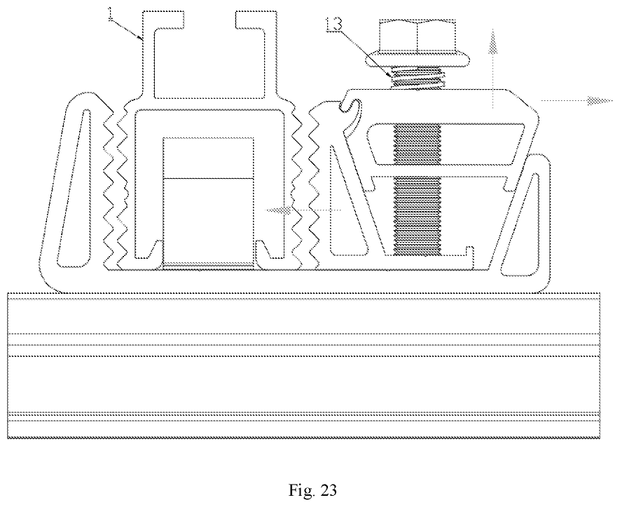

Firstly, as shown in FIG. 23, first, the rail blocks 1 are installed in the accommodating space 805, in such a case, since during pre-assembly, enough space is reserved for the rail blocks 1, and the angle of the rail blocks 1 may be adjusted according to requirements (the angle of rotation of the movable clamping block 3 in the installation groove 201 is within 10°, namely, the range of angle β of adjustment of the rail block 1 is within 10°, as shown in FIG. 16, β=6°.

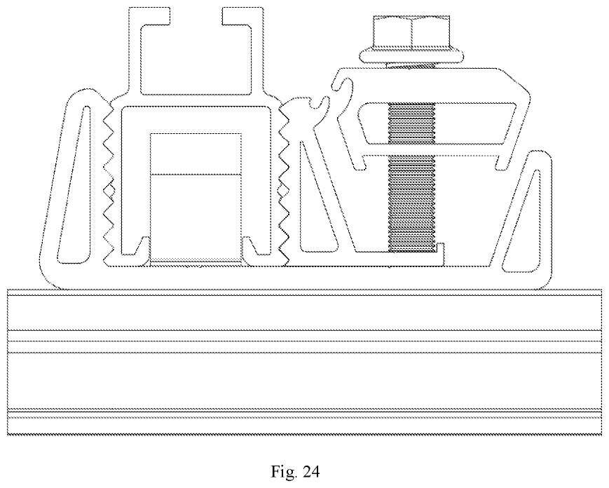

Secondly, as shown in FIG. 24, the third pressing block 7 is separated from the second pressing block 6.

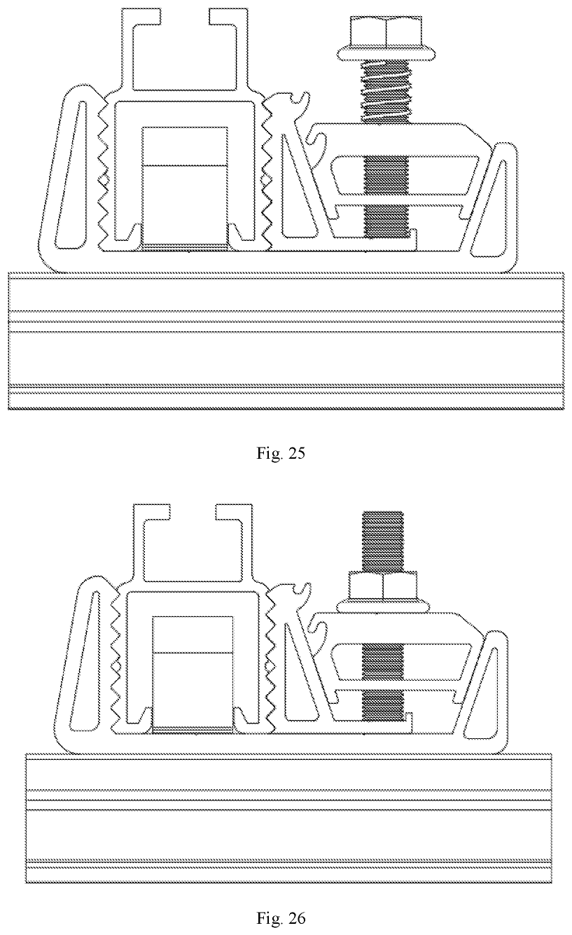

Thirdly, as shown in FIG. 25, the third pressing block 7 is downwards pressed, so that the third pressing block 7 is tightly pressed between the second clamping face 802 and the first bevel 602. During the downwards pressing process of the third pressing block 7, due to mutual action of the third bevel 704 and the second clamping face 802, and the mutual action of the second bevel 702 and the first bevel 602, the second pressing block 6 moves along one side of the rail block 1 (that is, along the side away from the third pressing block 7).

Fourthly, as shown in FIG. 26, force is downwards applied to screw the first nut 15, the first elastic part 13 is compressed, so that the second pressing block 6, the third pressing block 7 and the fourth pressing block 8 are locked on the base 2, and in such a case, the rail block 1 is clamped between the first clamping face 801 and the third clamping face 604.

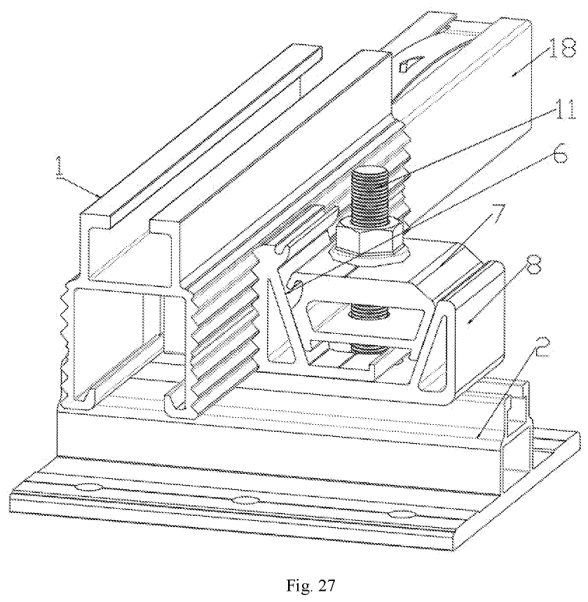

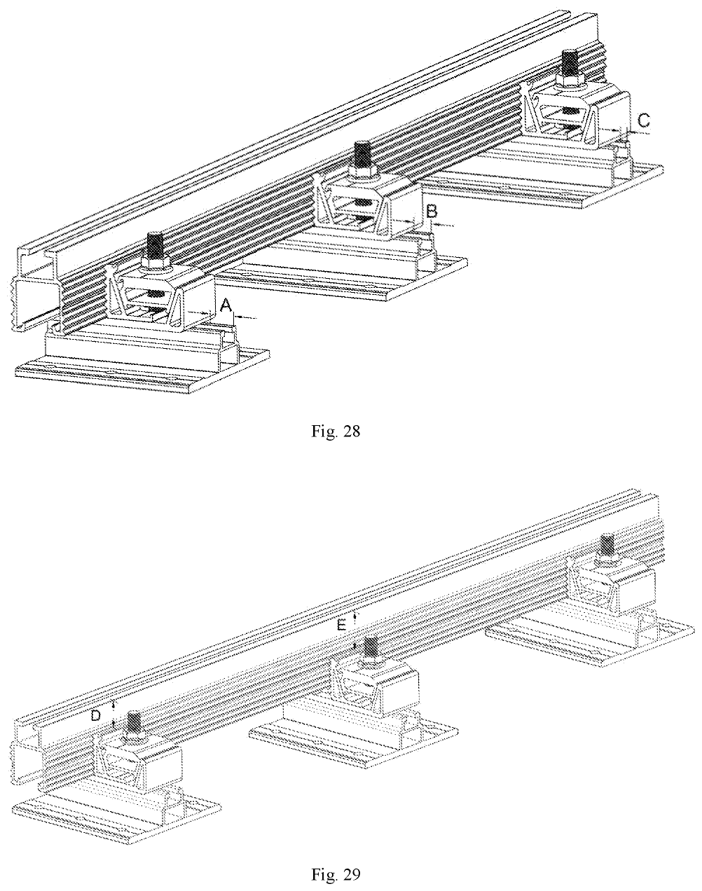

Lastly, as shown in FIGS. 27-29, when the rail needs to be extended, a connecting structure is installed between two rail blocks 1, the connecting structure is the same as that of Embodiment 1. The rail blocks 1 are fixed and supported by the fixing assembly of the application. The pressing block of the application may move within a displacement range (such as 45 mm) from the end in the installation groove 201 of the base 2 to adapt to the angle adjustment of each rail block 1, as shown in FIG. 28, size A>B>C. Meanwhile, if the base 2 is not on the same plane, the rail block 1 may be spaced at a certain height distance from the bottom face 803 of the fourth pressing block 8 (the adjustment range is within 10 mm) during installation, and the rail block 1 may be fixed by clamping between the first clamping face 801 and the third clamping face 604, and thus, fine adjustment of the fixed height of the rail block 1 on the base 2 may be realized, as shown in FIG. 29, size D<E.

The application is described by means of preferred embodiments, and the skilled in the art should know that various variations or equivalent replacements may be carried out on these features and embodiments without deviating from the spirit and scope of the application. The application is not limited by the specific embodiments disclosed herein, and other embodiments falling within the claims of the present application shall belong to the scope of protection of the application.

What is claimed is:

1. A rail fixing assembly, configured for fixing a rail formed by connecting rail blocks, comprising a base, pressing blocks, a movable clamping block and a fixing part; wherein
an installation groove is formed in the base, the pressing block is disposed above the base, an installation hole is formed in the pressing block, and a lower end of the movable clamping block is inserted into the installation groove after passing through the installation hole and is capable of moving or rotating in the installation groove; and
the rail block is installed at an upper end of the movable clamping block, the movable clamping block moves or rotates in the installation groove to realize position or angle adjustment, a side wall of the rail block abuts against the pressing block, and the pressing block is fixed on the base through the fixing part.

2. The rail fixing assembly according to claim 1, wherein
a fixed seat is configured on the base, the installation groove is formed in the fixed seat, and clamping steps are disposed on two sides, at an opening, of the installation groove; and
a clamping table is configured at a bottom of the movable clamping block, a width of the installation hole is greater than a maximal width of the movable clamping block, and the movable clamping block is clamped on the clamping steps through the clamping table after passing through the installation hole.

3. The rail fixing assembly according to claim 2, wherein
the pressing blocks comprise a first pressing block and a fifth pressing block;
a fixing part, an adjusting part and a first clamping part are disposed on the first pressing block, a height of the adjusting part is smaller than those of the fixing part and the first clamping part, the installation hole is formed in a bottom of the adjusting part, and a fixing hole is formed in the fixing part in a penetrating manner;
a horizontal pressing block plane is configured on one side of the fifth pressing block, the pressing block plane is installed on the fixing part, a pressing block hole is formed in the pressing block plane, a vertical fixed plane is disposed on other side of the fifth pressing block, and an accommodating space configured for installing the rail blocks is formed between the fixed plane and the first clamping part; and
the fixing part passes through the fixing hole and the pressing block hole to fix the first pressing block and the fifth pressing block on the base.

4. The rail fixing assembly according to claim 3, wherein
the side, contacting the first pressing block, of the fifth pressing block is designed to be a fourth bevel, a slope is configured on one side of the first pressing block, and the fourth bevel attaches to the slope.

5. The rail fixing assembly according to claim 3, wherein
the fixing part comprises a second bolt and a second nut, a head of the second bolt is engaged in the installation groove and limited on the clamping step, and a tail of the second bolt passes through the fixing hole and the pressing block hole and is locked by the second nut.

6. The rail fixing assembly according to claim 1, wherein
the pressing block comprises a second pressing block, a third pressing block and a fourth pressing block, the installation hole is formed in the fourth pressing block, the second pressing block and the third pressing block are installed on the fourth pressing block, and the fourth pressing block is installed on the base;
a second clamping part, a first bevel and a slot hole are configured on the second pressing block, a third clamping part, a second bevel and a through hole are disposed on the third pressing block, the second clamping part is clamped with or separated from the third clamping part, and the second bevel attaches to the first bevel;
the fixing part passes through the slot hole and the through hole to fix the second pressing block, the third pressing block and the fourth pressing block; and
when the second clamping part is clamped with the third clamping part, the fixing part is located at one end of the slot hole, the second clamping part is separated from the third clamping part, the fixing part is fastened, and the second pressing block moves towards the side away from the third pressing block.

7. The rail fixing assembly according to claim 6, wherein
a first clamping face and a second clamping face are configured on two sides of the fourth pressing block, a bottom face is connected between the first clamping face and the second clamping face, a locating hole is formed in the bottom face, the second pressing block is installed in middle of the bottom face, and the third pressing block is installed between the first bevel and the second clamping face.

8. The rail fixing assembly according to claim 7, wherein
a side, close to the first clamping face, of the second pressing block is designed to be a third clamping face, an accommodating space configured for installing rail blocks is formed between the third clamping face and the first clamping face, and corrugations are configured on both the first clamping face and the third clamping face.

9. The rail fixing assembly according to claim 7, wherein
a side, close to the second clamping face, of the third pressing block is designed to be a third bevel, and the second clamping face is slantwise disposed and attaches to the third bevel; and
the second bevel and the third bevel are designed to be tilted inward from top to bottom.

10. The rail fixing assembly according to claim 9, wherein
an angle between the third clamping face and the first bevel is 15°-45°, and the angle between the second clamping face and a vertical plane is 15°-45°.

11. The rail fixing assembly according to claim 6, wherein
a first groove and a first lug are configured on the second clamping part, a second groove and a second lug are configured on the third clamping part, when the second clamping part is clamped with the third clamping part, the second lug is located in the first groove, and the first groove is located in the second depression.

12. The rail fixing assembly according to claim 11, wherein
a depth of the first groove is smaller than that of the second groove, and a convex length of the first lug is greater than that of the second lug.

13. The rail fixing assembly according to claim 6, wherein
the fixing part comprises a first bolt, a first nut and a first elastic part, a stepped groove is configured above the through hole, and the first elastic part is installed in the stepped groove; the first bolt penetrates through the first elastic part to be locked with the first nut.

14. The rail fixing assembly according to claim 1, wherein
an angle of rotation of the movable clamping block in the installation groove is within 10°, so that the rail block realizes angle adjustment within 10°.

15. The rail fixing assembly according to claim 3, wherein
the rail block is installed between the fixed plane and the first clamping part, and the rail block is adjustable in a vertical direction between the fixed plane and the first clamping part; and
corrugations are disposed on sides, attaching to the rail block, of the fixed plane and the first clamping part, and corrugations are disposed on two sides of the rail block.

16. The rail fixing assembly according to claim 3, wherein
a bulge is configured on one side of the fixing part, the bulge attaches to the fifth pressing block, so that a gap is configured between the pressing block hole and the installation hole, and a second elastic part is equipped in the gap.

17. The rail fixing assembly according to claim 1, further comprising a connecting strip, wherein a base groove configured for installing a base is designed at a top of the rail block, a channel configured for placing the connecting structure is formed at a bottom of the rail block, and two ends of the connecting structure are respectively inserted in the channels of two rail blocks.

18. The rail fixing assembly according to claim 17, wherein
an installation notch is formed in the connecting strip, guide lugs are disposed on two sides of the installation notch, a metal elastic sheet is disposed in the installation notch, and two sides of the elastic sheet are located in the guide lugs.

19. The rail fixing assembly according to claim 18, wherein
clamping hooks are configured on two sides of a bottom of the channel, installation ramps are disposed on two sides of a bottom of the connecting strip, the installation ramps are adaptive to the clamping hooks, a convex block is disposed in middle of the metal elastic sheet, and the convex block attaches to outer walls of two adjacent connected rail blocks.

20. The rail fixing assembly according to claim 18, wherein
a scraper is disposed on the metal elastic sheet, and the scraper attaches to bottoms of two rail blocks.
